(19) United States
(12) Patent Application Publication
(10) Pub. No.: US 2013/0111790 A1
(43) Pub. Date: May 9, 2013

(54) ENERGY-SAVING BILLBOARD MODULE

(71) Applicants: Sheng Tsai Tseng, Kaohsiung City (TW); Sheng Lan Tseng, Kaohsiung City (TW)

(72) Inventors: Sheng Tsai Tseng, Kaohsiung City (TW); Sheng Lan Tseng, Kaohsiung City (TW)

(21) Appl. No.: 13/437,235

(22) Filed: Apr. 2, 2012

(30) Foreign Application Priority Data
Nov. 7, 2011 (TW) 100221001

(51) Int. Cl. G09F 13/00

(52) U.S. Cl. 40/541

(57) ABSTRACT

An energy-saving billboard module includes a solar energy module, a billboard, a light-emitting element, a storage cell, and a controller, which are accommodated in an outer frame. The billboard is adhered on the solar energy module and has transparent patterns. A light sensor is disposed on a top of the outer frame for sensing the luminance of sunlight to generate a sensing signal. The solar energy module receives sunlight and generates an electric power to charge the storage cell for outputting another electric power. The controller and the light sensor are supplied with the electric power outputted from the storage cell. The electric power of the storage cell is controlled by the controller based on the sensing signal so as to enable the light-emitting element to generate an emitting light for irradiating onto the billboard, so that the patterns of the billboard can be displayed.

### BACKGROUND OF THE INVENTION

1. Field of the Invention

The present invention relates to an energy-saving billboard module, and more particularly to an energy-saving billboard module which employs a solar energy module to generate electric power and enables a light-emitting element to show the patterns of a billboard.

2. The Prior Arts

Under the condition that the ambient light or illumination is weak, a billboard, such as a traffic billboard with identification or warning purpose, a commercial billboard for promoting products, or a billboard with suitable pictures for decorating buildings or sights, requires an additional light source to show a bulletin function. Light-emitting elements, such as fluorescent lamp, sodium lamp or light-emitting diode (LED), with high efficiency and high luminance are often used as an additional light source and are supplied with electric power by mains electricity or storage cell.

The use of solar energy as the source of initial electric power has become a universal trend for saving energy and reducing carbon emission. Various products employing solar energy are found in the market. Generally, a solar panel is flatly disposed on a top for providing a largest sunlight receiving area. However, it will result in a bulky billboard size, and therefore its application field and convenience are limited.

Therefore, it is desired to provide an energy-saving billboard module, which enables a solar panel to be disposed vertically and in parallel to the billboard with characters or graphics. The solar panel converts sunlight into electric power for used in showing the content of the billboard. As a result, the technical problems mentioned above can be solved.

### SUMMARY OF THE INVENTION

A primary objective of the present invention is to provide an energy-saving billboard module which comprises at least one solar energy module, at least one billboard, at least one light-emitting element, a storage cell, a controller, a light sensor and an outer frame. Each of the solar energy modules receives sunlight and generates an electric power. Each of the billboards is adhered on a corresponding solar energy module and has transparent patterns. The storage cell is charged by the electric power generated by the solar energy modules and outputs another electric power. The light sensor receives the electric power outputted by the storage cell and senses the luminance of sunlight so as to generate a sensing signal. The controller receives the sensing signal sensed by the light sensor and controls the electric power outputted by the storage cell based on the sensing signal so as to enable the light-emitting element to generate an emitting light. The solar energy module, the billboard, the controller and the storage cell are accommodated in the outer frame, and the light sensor is disposed on a top of the outer frame. The patterns of the billboard can be displayed in view that the billboard is irradiated by the emitting light generated by the light-emitting element.

Furthermore, a waterproof top cover can be disposed on the top of the outer frame, and the solar energy module, the light-emitting element or the billboard can be replaced by opening the top cover.

Therefore, the energy-saving billboard module of the present invention can implement a bulletin function. And an external power supply is not needed since sunlight or ambient light can be received by the solar energy module to generate the required electric power. As a result, the purpose of saving energy and reducing carbon emission can be achieved. Additionally, the energy-saving billboard module of the present invention is waterproof, which ensures the reliability of operation. The convenience of maintenance can also be enhanced because all of the elements can be replaced by opening the top cover of the outer frame.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a structural schematic view of an energy-saving billboard module according to an embodiment of the present invention;

FIG. 2 is a front view of the energy-saving billboard module shown in FIG. 1;

FIG. 3 is a schematic view of an arrangement of light-emitting elements in FIG. 1;

FIG. 4 is a structural schematic view of an energy-saving billboard module according to another embodiment of the present invention; and

FIG. 5 is a schematic view of another arrangement of the light-emitting elements of the present invention.

### DETAILED DESCRIPTION OF THE PREFERRED EMBODIMENT

The present invention will become more fully understood by reference to the following detailed description thereof when read in conjunction with the attached drawings.

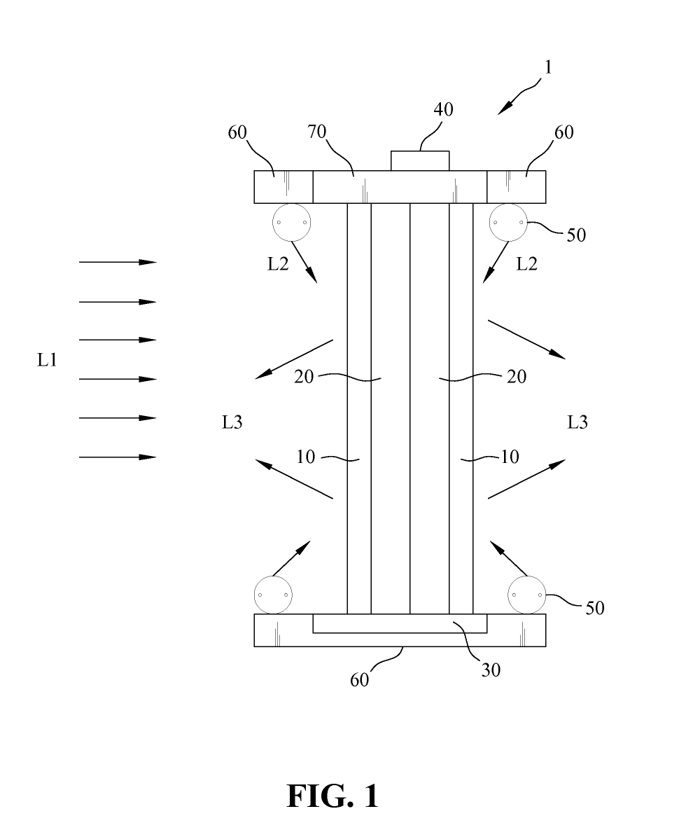

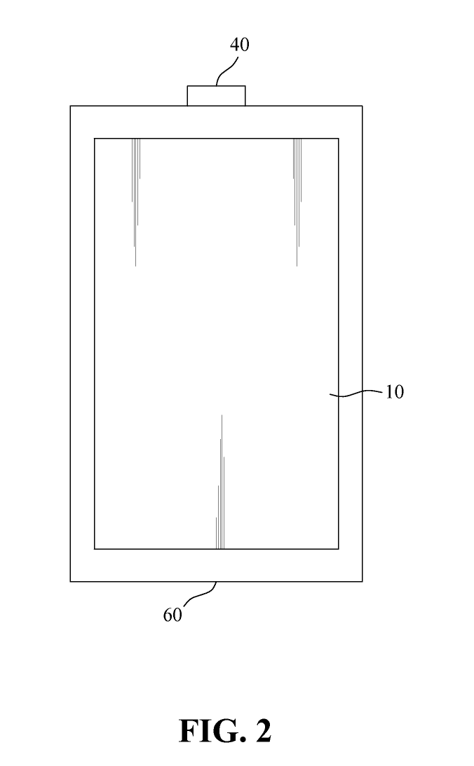

FIGS. 1 and 2 are a structural schematic view and a front view of an energy-saving billboard module in accordance with the present invention, respectively. As shown in FIGS. 1 and 2, the energy-saving billboard module 1 of the present invention comprises at least one billboard 10, at least one solar energy module 20, a storage cell 30, a light sensor 40, at least one light-emitting element 50, a controller (not shown in the drawings) and an outer frame 60 for implementing an energy-saving bulletin function.

It should be noted that two billboards 10, two solar energy modules 20, and four light-emitting elements 50 shown in FIGS. 1 and 2 are merely used for describing the embodiment of the present invention, and they should not be construed as limitations to the present invention. Therefore, any numbers of the billboards 10, the solar energy modules 20 and the light-emitting elements 50 can be comprised in the present invention.

The billboards 10, the solar energy modules 20, the storage cell 30 and the controller are accommodated in the outer frame 60. Outer sides of the billboards 10 can be exposed outside the outer frame 60. The light sensor 40 can be disposed on a top of the outer frame 60 or a top of the energy-saving billboard module 1.

Each of the billboards 10 can be made of acrylic board or glass, and has transparent patterns such as characters, symbols, product graphics or images arranged by different color or concave and convex surfaces.

Each of the solar energy modules 20 is adhered on an inner side of the corresponding billboard 10. Sunlight L1 or ambient light transmits through the billboards 10 and is received by the solar energy modules 20 so as to generate a first electric power.

The storage cell 30 can be disposed in a bottom of the energy-saving billboard module 1. The storage cell 30 receives the first electric power generated by the solar energy modules 20 and is charged as so to output a second electric power. The storage cell 30 can be a rechargeable secondary cell.

The light sensor 40 receives the second electric power outputted by the storage cell 30 and is used for sensing the luminance of the sunlight L1 and generating a sensing signal (not shown in the drawings).

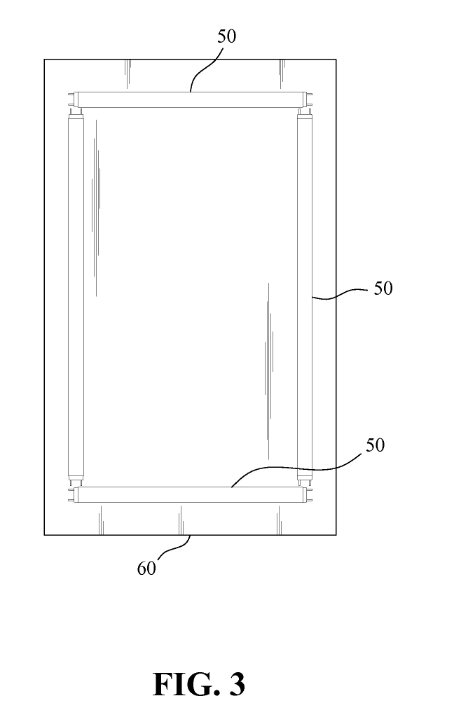

The light-emitting elements 50 are disposed on outer sides of the billboards 10. The light-emitting elements 50 can be light emitting diodes (LEDs) or LED light tubes. Furthermore, as shown in FIG. 3, the light-emitting elements 50 can be spaced evenly and disposed horizontally, vertically or slantingly (not shown in the drawings). The arrangement of the light-emitting elements 50 shown in FIG. 3 is merely for an illustration purpose, and the light-emitting elements 50 can be arranged in any manner.

The controller receives the sensing signal of the light sensor 40 and controls the second electric power outputted by the storage cell 30 based on the sensing signal, so as to turn off or turn on the light-emitting elements 50 to generate an emitting light L2. For example, when the luminance of the sunlight L1 is higher than a preset value, that means the ambient light is bright enough without having to turn on the light-emitting elements 50, the light sensor 40 sets the sensing signal at a high level so as to make the controller turn off the light-emitting elements 50. When the luminance of the sunlight L1 is lower than the preset value, the sensing signal is set at a low level so as to make the controller turn on the light-emitting elements 50 to generate the emitting light L2, and the emitting light L2 is irradiated onto the billboards 10. The emitting light L2 is then reflected to form a reflecting light L3 away from the energy-saving billboard module 1. The patterns of the billboards 10 can be displayed due to the reflecting light L3. Accordingly, an energy-saving bulletin function is achieved.

Furthermore, the energy-saving billboard module 1 of the present invention can further comprise a top cover 70 which is disposed on the top of the energy-saving billboard module 1 and is disassembly connected with the outer frame 60. The billboards 10 or the solar energy modules 20 can be replaced when the top cover 70 is opened, and therefore it is more convenient for maintenance. The top cover 70 is waterproof so as to prevent water from getting into the energy-saving billboard module 1 to provide protection.

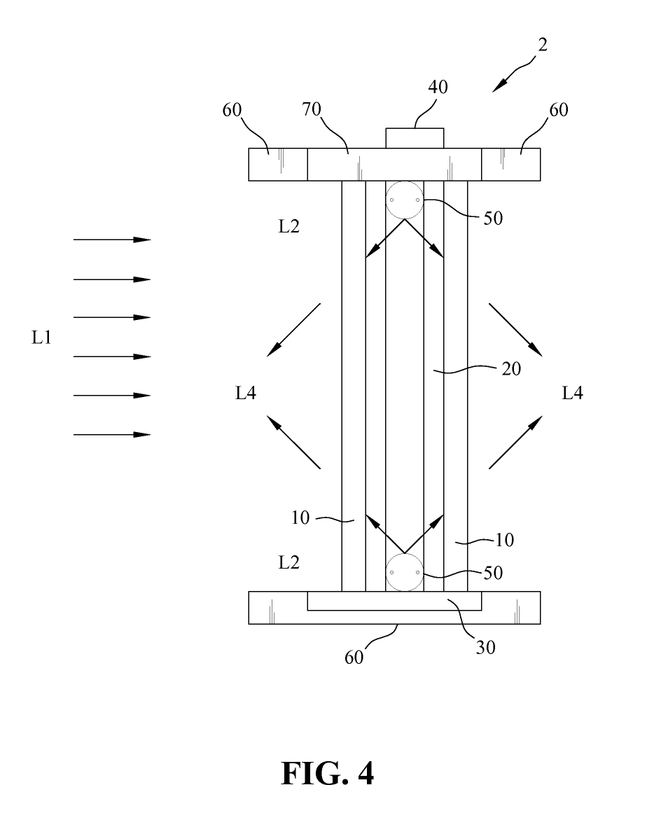

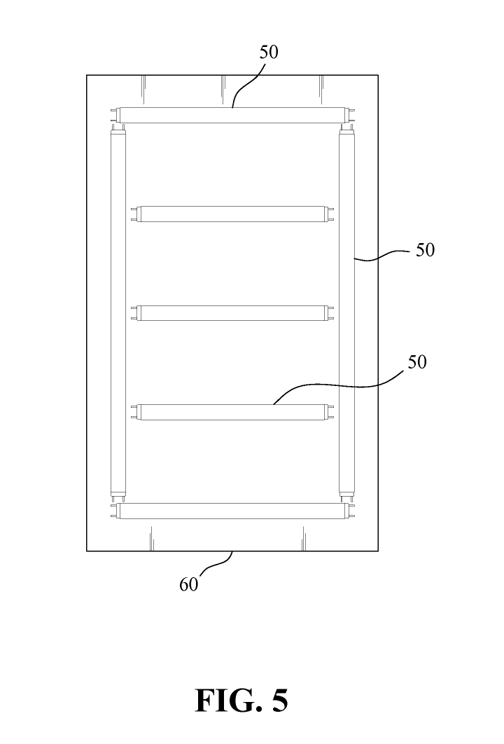

FIG. 4 is a structural schematic view of an energy-saving billboard module according to another embodiment of the present invention. The energy-saving billboard module 2 is similar to the energy-saving billboard module 1 in FIG. 1. The main difference between the two modules lies in that: the light-emitting elements 50 of the energy-saving billboard module 2 are disposed on inner sides of the solar energy modules 20. That means the light-emitting elements 50 are disposed between the solar energy modules 20. The functions of the other elements are similar to those of the energy-saving billboard module 1 which will not be mentioned herein again. Therefore, the emitting light L2 generated by the solar energy modules 20 transmits through the solar energy modules 20 and the billboards 10 to form a transmitting light L4, so that the patterns of the billboards 10 can be displayed due to the transmitting light L4. Furthermore, as shown in FIG. 5, the light-emitting elements 50 can be spaced evenly and disposed horizontally, vertically or slantingly (not shown in the drawings). The arrangement of the light-emitting elements 50 shown in FIG. 5 is merely for an illustration purpose, and the light-emitting elements 50 can be arranged in any manner.

It should be noted that the energy-saving billboard modules in FIGS. 1 to 5 can receive sunlight from both sides to show a bulletin function by both sides, which are only for illustrative embodiments. Nevertheless, the energy-saving billboard modules of the present invention can also be designed to receive sunlight from a single side to show a bulletin function by a single side. Therefore, receiving sunlight from a single side to show a bulletin function by a single side, receiving sunlight from both sides to show a bulletin function by a single side, receiving sunlight from a single side to show a bulletin function by both sides as well as receiving sunlight from both sides to show a bulletin function by both sides are all covered by the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An energy-saving billboard module having a bulletin function, comprising:
at least one billboard each having transparent patterns;
at least one solar energy module each receiving sunlight or ambient light to generate a first electric power, and the solar energy module adhered on an inner side of a corresponding billboard;
a storage cell receiving the first electric power and being charged so as to output a second electric power, and the storage cell being disposed in a bottom of the energy-saving billboard module;
a light sensor disposed on a top of the energy-saving billboard module and receiving the second electric power for sensing the luminance of the sunlight and generating a sensing signal;
a light-emitting element disposed on the inner side or an outer side of the billboard;
a controller receiving the sensing signal and controlling the second electric power outputted by the storage cell based on the sensing signal, so as to turn off or turn on the light-emitting element to generate an emitting light, wherein the emitting light is reflected by or transmitted through the billboard, so that the patterns of the billboard is displayed; and
an outer frame for accommodating the billboard, the solar energy module, the controller, and the storage cell, wherein outer sides of the billboard is exposed outside the outer frame, and the light sensor is disposed on a top of the outer frame.

2. The energy-saving billboard module as claimed in claim 1, wherein the billboard is made of acrylic board or glass, and has transparent patterns such as characters, symbols, product graphics or images arranged by different color or concave and convex surfaces.

3. The energy-saving billboard module as claimed in claim 1, wherein the light-emitting element is light emitting diode (LED) or LED light tube, and the light-emitting elements are spaced evenly and disposed horizontally, vertically or slantingly, and the storage cell is a rechargeable secondary cell.

4. The energy-saving billboard module as claimed in claim 1, further comprising a top cover disposed on a top of the energy-saving billboard module, and is disassembly connected with the outer frame, and the solar energy module, wherein the solar energy module, the light-emitting element, and the billboard can be replaced when the top cover is opened, and the top cover is waterproof when the top cover is closed.
